(19) United States
(12) Patent Application Publication
(10) Pub. No.: US 2003/0197617 A1
(43) Pub. Date: Oct. 23, 2003

(54) Fluid metering system for preventing flood damage or fluid leakage

(75) Inventors: Benjamin Berger, Haifa (IL); Zev Weintraub, Brooklyn, NY (US); Saul Gertzulin, Monsey, NY (US)

Correspondence Address: EZRA SUTTON, P.A., PLAZA 9, 900 ROUTE 9, WOODBRIDGE, NJ, 07095, US

(73) Assignee: National Water Management, Inc.

(21) Appl. No.: 10/127,407

(22) Filed: Apr. 23, 2002

(51) Int. Cl. G08B 21/00

(52) U.S. Cl. 340/605; 137/803

(57) ABSTRACT

A household fluid flow-rate monitor and control system is provided to prevent flood damage, fluid leakage and loss of fluid. The system includes a plurality of alarm units for monitoring fluid flow in the system; an automatic electrically operated valve for shutting off the fluid flow to prevent damage; a fluid meter for sending to a monitor an electrical signal for every unit of fluid flowing through the system; and a controller unit including a microprocessor unit and a memory unit connected to the automatic valve to shut off the system. The monitor receives input from the fluid meter or from a flood sensor and sends alarm signals for several types of events, such as burst flow, leakage, flood, etc. to the controller unit. The unit also has a manual override switch to bypass the electronics.

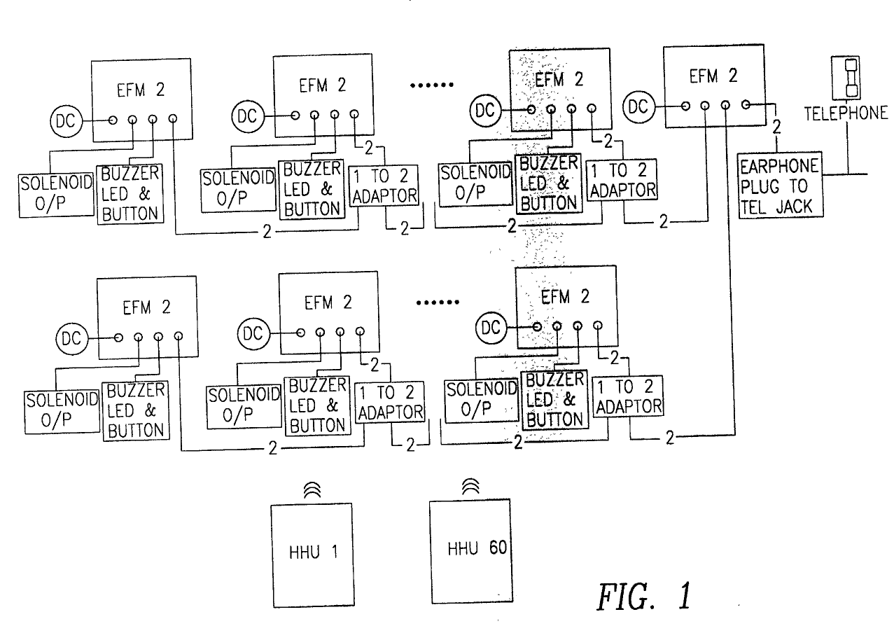

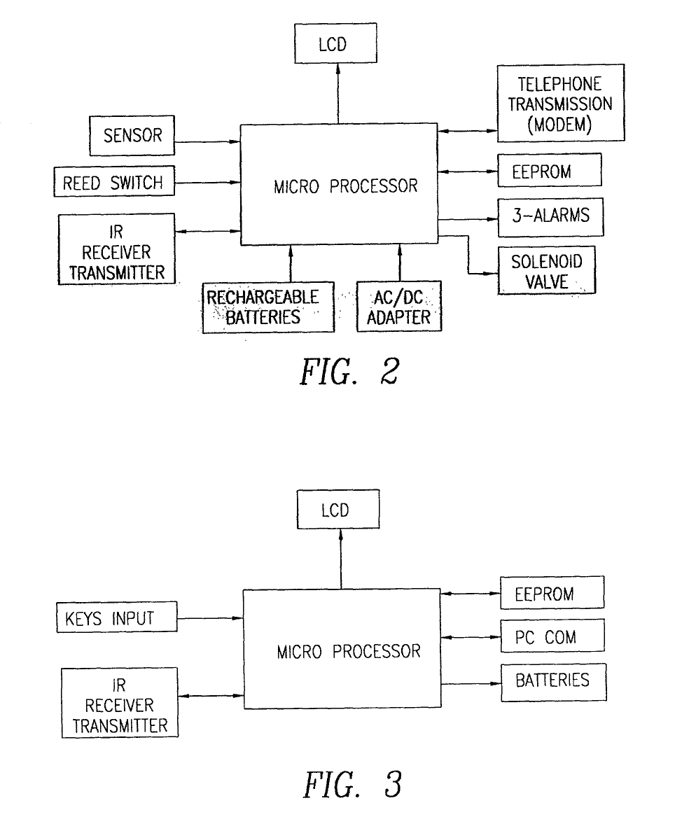

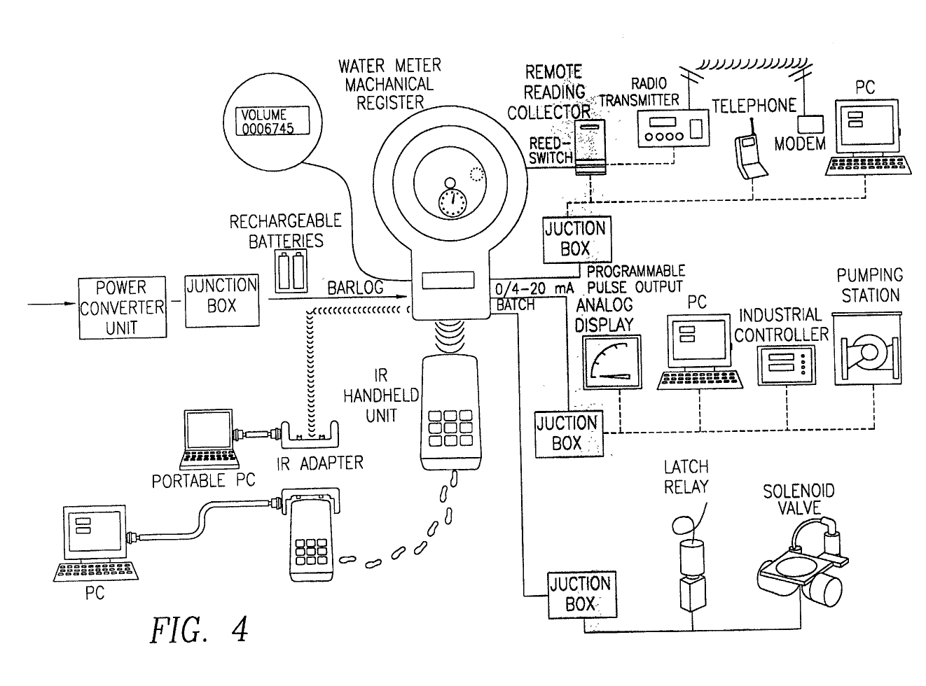

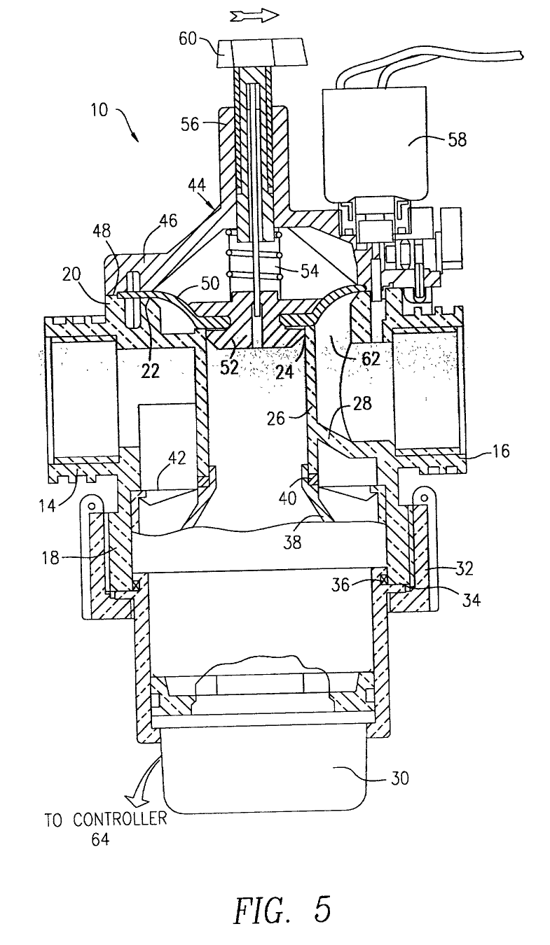

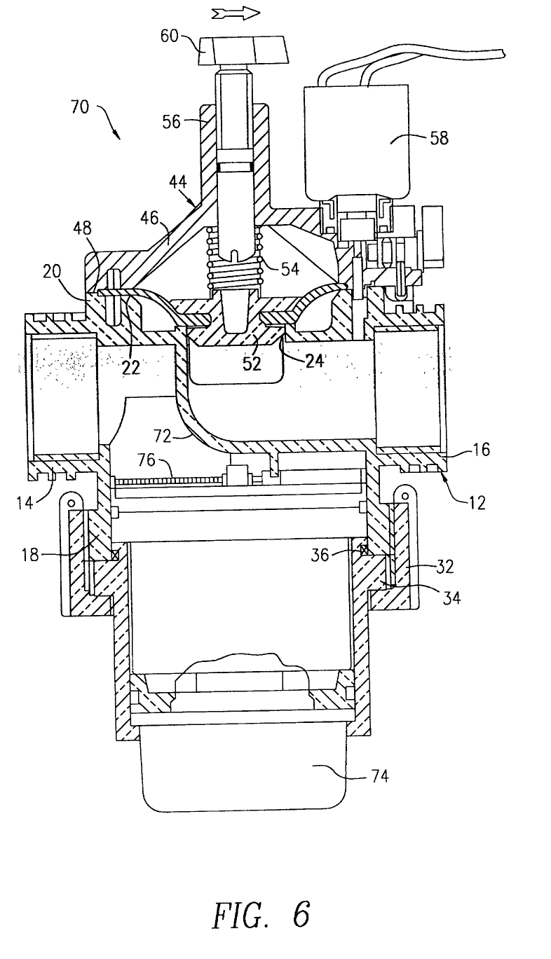

### FIELD OF INVENTION

The system prevents flood damage, fluid leakage and loss of fluid and includes alarm units for monitoring the fluid flow, a valve for shutting off the fluid flow, a fluid meter for sending to a monitor an electrical signal for each unit of fluid flow, a monitor for receiving input from the fluid meter and for providing alarm signals to a control unit which operates the valve to shut off the fluid flow in the system. Further, the present invention relates to water control devices including a housing integrally formed with a water meter and a water flow control valve.

### SUMMARY OF THE INVENTION

A household fluid flow-rate monitor and control system is provided to prevent flood damage, fluid leakage and loss of fluid. The system includes a plurality of alarm units for monitoring fluid flow in the system; an automatic electrically operated valve for shutting off the fluid flow to prevent damage; a fluid meter for sending to a monitor an electrical signal for every unit of fluid flowing through the system; and a controller unit including a microprocessor unit and a memory unit connected to the automatic valve to shut off the system. The monitor receives input from the fluid meter or from a flood sensor and sends alarm signals for several types of events, such as burst flow, leakage, flood, etc. to the controller unit.

### DESCRIPTION OF THE INVENTION

The invention comprises two units: 1) a combination of an electric flow metering valve which emits electric pulses and an electronic controller-monitor; and 2) a communications system which connects the controller to a control center.

The two units can be either separate (as it is in the large sizes), or physically combines (as described in Patent No. PCT/IL99/00548 for Control Device for water).

The controller was developed especially for this invention, and it will be henceforth known as BARLOG II.

The BARLOG II is so designed that it can be used either as a standalone unit or as part of a communications system to a control center.

In the standalone formation it serves to protect residential apartments, houses or businesses against adverse occurrences such as leakage, bursts or flooding of water (hot or cold) or gas. In this formation it may also be connected to a central communications system, but the owners of the business or apartment retain the possibility of programming the controller by a Hand Held Unit (HHU) and receiving alarm signals and automatic valve closure in case of an adverse occurrence.

When BARLOG II forms a part of a communications system to a control center, all alarm signals will be directed to the control center and the center will take care to activate the valves, repair the faults and notifying the landlord.

BARLOG II is designed with the option of connecting it to an external system by means of an interface unit, called BARLOG III. BARLOG III is capable of serially connecting to several BARLOG II units. (Please see schematic of a multi-line telephone system).

The present invention uses a modular water meter which can be mounted to and removed from the unitary housing at will without disturbing the other components of the water control device. This permits installation of water meters which already meet the requirements and codes of local municipalities or water authorities, without having to go through the time-consuming formalities of qualifying a new kind of meter. The present invention can be carried out with any kind of meter, such as a volumetric flow meter or flow velocity meter, and any kind of water control valve, such as a diaphragm valve or solenoid valve. The unitary construction of the housing realizes significant savings in manufacturing costs.

There is thus provided in accordance with a preferred embodiment of the present invention a water control device including a housing, including as one unit, an inlet port and an exit port for flow therethrough of water, and a water meter mounting flange and a water flow control valve seat member in fluid communication with each other and with at least one of the inlet and outlet ports, and a water meter sealingly attached to the water meter mounting flange, and a water flow control valve sealingly attached to the water flow control valve seat member.

In accordance with a preferred embodiment of the present invention the water meter includes a modular meter removably attachable to the water meter mounting flange.

Further in accordance with a preferred embodiment of the present invention a controller is provided which controls operation of at least one of the water meter and the water control valve.

### EFM 2 Unit

When the EFM 2 unit detects any alarm condition, it will turn on the buzzer and LED if necessary. At the same time, it will transmit a warning message to the EFM 3 unit by the two-wire serial links. The EFM 3 unit will send the warning type and the EFM ID number to the main station thought the telephone line. It will also shut down water supply.

### Handheld Unit HHU1

The EFM 2 unit has a two-wire serial interface. Infrared digital communication between the EFM 2 unit and the HHU unit will be maintained. Two new HHU units will be used, i.e. HHU 1 unit (for one EFM 2 unit only) and HHU 80 units for EFM 2 units. The EFM 2 unit can work as a stand-alone unit or be linked together with an EFM 3 unit. The EFM 2 unit housing contains four holes for four terminals. The alarm works in two modes i.e. at Home mode and Out/Night mode. One terminal is used for the DC power supply; one terminal is used to control the valve solenoid; one terminal is used as the serial interface terminal; and one terminal is used for driving the Buzzer and the LED. Each unit will use its EFM ID number for identification. It can also connect to household alarm panel via dry contact (which was just added)

### EFM 3 Unit

The EFM 3 unit is a stand-alone unit with a two-wire serial interface and a telephone line interface. It communicates with the EFM 2 units by a two-wire serial interface and with the computer station by a telephone interface, radio, cell phone. The EFM 3 unit housing contains four holes for four (4) terminals. One terminal is used for the DC power supply; two terminals are used for the serial interface terminals; and one terminal is used for the earphone plug to the telephone jack of the telephone line interface terminal.

The Handheld Unit (HHU 1) works with the EFM 2 unit only. It can store the data of one EFM 2 unit only. It can be used to change the operation mode of the EFM 2 unit (In home mode and out/night mode). It can be used to turn on/off the valve. The keys for the HHU 1 unit are a clock, change display, or send, setup view, edit, valve on, valve off, Home mode, Out/Night mode, and the Alarm programing key.

The Handheld Unit 80 (HHU) works with the EFM 2 unit. It can store the data of up to 80 EFM 2 units. It has all the functions of the HHU 1 unit.

Leakage Alarm

In the At Home mode, when the flow rate is higher than a preset limit for a programed period of time, the alarm will turn on and send a signal to the main station immediately. The valve is then programmed to be closed after five (5) minutes. In the Out/Night mode, when the flow rate is higher than a preset limit for two (2) hours, the alarm will turn on and send a signal to the main station immediately. Then the valve will be closed after 5 minutes.

EFM 2 Alarms

There are four alarms in each EFM 2 unit to detect the water flow. When the preset conditions are matched, the alarm will turn on and/or send the alarm signal to the main station through the EFM 3 unit and the valve will be turned off. The alarm can be turned off by the switch or by the main station and the valve can be turned on again by the HHU unit or by the main station.

Maximum Flow Rate Alarm

In the At Home mode or the Out/Night mode, when the flow rate is higher than a preset limit for a preset period, the alarm will turn on and send an alarm signal to the main station immediately. Then, the valve will be closed after 1 minute.

Constant Flow Rate Alarm

In the At Home mode, when the flow rate is higher than a preset limit for a preset period of time, excluding the alarm off period, and the change in the present period is lesser than ±10%, the alarm will turn on and send an alarm signal to the main station immediately. Then, the valve will be closed after five (5) minutes.

In the Out/Night mode, when the flow rate is higher than a preset limit for a preset period, excluding the alarm off period, the alarm will turn on and send an alarm signal to the main station immediately. Then, the valve will be closed after five (5) minutes.

Maximum Consumption Alarm

When the accumulated consumption for a preset period is higher than a preset limit, the alarm signal will be sent to the main station immediately.

The Serial Interface

One line is a clock signal generated by the sender (EFM 2 or EFM 3 unit). The other units will synchronize with this clock for data transmission. The other line is a data signal. The SI and SO pins are connected together. Data transfers in LSB first. The data will change the state when the clock is falling. The data will read when the clock is rising.

Telephone Line Interface

The EFM 3 unit has a telephone line interface to communicate with the main station though the telephone line. It will not affect the normal usage of the telephone line. It will use the 16 Dual Tone Multi Frequency (DTMF) digits for communication. Table A shows the DTMF tone dialing matrix.

Telephone Line Interface Timing

All the command and data will be started with tone “C” and end with tone “B.” The duration of the tone, tₜₒₙₑ is from 20 ms to 40 ms. The duration of the Inter-Digit Pause, t_{idp} is from 20 ms to 40 ms.

### Water Control Device

The water control device 10 comprises a housing 12 including the following elements as a unitary housing: an inlet port 14, an exit port 16, so water may flow therethrough; a water meter 30 attached to a water meter mounting flange 18; the water meter mounting flange 18 being in fluid communication with a water flow control valve seat member 20 having inlet and outlet ports 14 and 16; and a water flow control valve 44 attached to the water flow control valve seat 20.

The water meter 30 is a modular meter removably attachable to the water meter mounting flange 18. The water control device 10 further includes a controller 64 which controls the operation of water meter 30 and water flow control valve 44. The controller 64 is part of a pre-payment water meter system 66. The water meter 30 may be a velocity water meter or a volumetric flow water meter 74. The water control valve 44 is a diaphragm control valve. Water flow control valve 44 is operable by a solenoid 58. The solenoid 58 is operatively connected to the water flow control valve 44.

### Operation of the Present Invention

Installation

If the EFM 2 unit is working as a stand-alone unit, the serial terminal is left unconnected. If the EFM 2 unit is to communicate with the main station, the serial terminal is connected to the EFM 3 unit. During installation of the Barlog II system, the EFM ID number and password of all the EFM 2 units should be recorded and input into the main station. The main station sends the main station telephone number to the EFM 3 unit by the command (function code=21) after the system is installed. The EFM 3 unit stores this number into EEPROM when it is received. The EFM 2 units may be set up by the HHU 1 unit or the HHU 80 unit or the main station.

Normal Operation

The alarm parameters in the EFM 2 unit can be changed by the HHU 1 unit or the HHU 80 unit or the main station through the EFM 3 unit. If the HHU unit is selected, the user can set the EFM 2 unit in the Home Mode or the Out/Night mode by using the Home key and Out/Night key. If Door Activation is selected, opening the EFM 2 door will set the EFM 2 unit in the Home Mode, while closing the door will set in the Out/Night mode.

Alarm On and Off

When the EFM 2 unit is set to detect any alarm condition match, it will turn on the alarm and/or send the alarm signal to the EFM 3 unit and/or close the valve automatically.

When someone turns off the alarm by the switch, the alarm off signal is sent to the EFM 3 unit. Then the EFM 3 unit sends this signal to the main station. The main station can also send the alarm off signal to the EFM 2 unit through the EFM 3 unit by the telephone interface.

Communication Between the EFM 2 Unit the EFM 3 Unit and the Main Station

When the EFM 3 unit receives command/data from the EFM 2 unit, it will reply to the EFM 2 unit by sending an Acknowledgment command signal back through the serial interface. And it will modify the command signal (if necessary) and send it to the main station through the telephone interface. When the EFM 3 unit receives the command signal from the main station, it will modify the command signal (if necessary) and send it out through the serial interface. All the EFM 2 units that are connected to the EFM 3 unit and will check the EFM ID number in the message with their ID number. Then they will reply (Send data or Acknowledgment) to the EFM 3 unit if it matches. If the EFM 3 unit does not receive any reply from the serial interface for a period of time, it is assumed that there is no match to EFM unit in this system. Then the No Acknowledgment command signal is sent to the main station. If the EFM 3 unit receives the reply from the EFM 2 unit, it will modify and send it to the main station through the telephone interface. The EFM 3 unit will act as the interface between the main station and all the EFM 2 units only. It will not store any information of the EFM 2 units. Every time the EFM 2 or EFM 3 units are ready to send the command signal through the serial interface, it will check whether the line is empty before (by checking the clock line in the serial interface). If the line is busy, it will delay for a few seconds (random number) and check the line again. When the line is empty, it will generate the clock signal and send the data.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A househould fluid flow-rate monitor and control system to prevent flood damage, fluid leakage and loss of fluid, comprising:
a) a plurality of alarm units for monitoring fluid flow;
b) an automatic electrically operated valve for shutting off the fluid flow to prevent damage;
c) a fluid meter for sending to a monitor an electrical signal for every unit of fluid flowing through the system;
d) a monitor for receiving input from said fluid meter or from a flood sensor and for providing alarm signals for several types of events, such as burst flow, leakage, flood, etc. to a controller unit; and
e) a controller unit including a microprocessor unit and a memory unit connected to said automatic valve to shut off the fluid flow in the system.

2. A system in accordance with claim 1, wherein said monitor activates a unit which contains either visual (blinking light) or sound alarm devices, and after a presettable delay, may command said automatic valve to shut off the fluid flow in the system.

3. A system in accordance with claim 1, wherein said monitor is powered by the electric network and/or a rechargeable battery.

4. A system in accordance with claim 1, wherein said monitor can be set either through an infrared remote control unit or directly through a command from a P.C. program.

5. A system in accordance with claim 1, wherein said monitor transmits alarm signals to said control unit by a telephone line, an infrared radio or a cellular telephone.

6. A system in accordance with claim 1, wherein said unit includes management software for automatic and manual problem solving and repair.

7. A system in accordance with claim 1, wherein said automatic valve is a latching solenoid valve acting as the main shutoff valve for maintaining an Open or Close positions of fluid flow in the system.

8. A system in accordance with claim 1, wherein said entire system is contained in a compact housing.

9. A system in accordance with claim 1, comprising a special program to activate said automatic valve for a quick fluid flow shutoff when no one is at home.

10. A water control device comprising:
a) a housing having an inlet port and an exit port for water to flow therethrough; and a water meter mounting flange and a water flow control valve seat member in fluid communication with each other and with said inlet and outlet ports;
b) said housing and said components forming an integral unit;
c) a water meter attached to said water meter mounting flange; and
d) a water flow control valve attached to said water flow control valve seat member.

11. The water control device according to claim 10, wherein said water meter includes a modular meter removably attachable to said water meter mounting flange.

12. The water control device according to claim 10, further comprising a controller which controls operation of at least one of said water meter and said water flow control valve.

13. The water control device according to claim 10, wherein said water meter includes a flow velocity water meter.

14. The water control device according to claim 10, wherein said water meter includes a volumetric flow water meter.

15. The water control device according to claim 10, wherein said water flow control valve includes a diaphragm control valve.

16. The water control device according to claim 10, wherein said water flow control valve is operable by a solenoid.

17. The water control device according to claim 10, further includes a solenoid operatively connected to said water flow control valve.
